(19) United States
(12) Patent Application Publication
(10) Pub. No.: US 2011/0026529 A1
(43) Pub. Date: Feb. 3, 2011

(54) Method And Apparatus For Option-based Marking Of A DHCP Packet

(76) Inventors: Saugat Majumdar, Roseville, CA (US); Shaun Kazuo Wakumoto, Roseville, CA (US); Charles F. Clark, Roseville, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/534,078

(22) Filed: Jul. 31, 2009

(51) Int. Cl. H04L 12/56; H04L 12/28

(52) U.S. Cl. 370/393; 370/392

(57) ABSTRACT

A method and apparatus for processing a Dynamic Host Configuration Protocol (DHCP) packet in a trusted network are disclosed. The trusted network includes a plurality of trusted network devices and a trusted host. The DHCP packet is received at a network device of the trusted network. A port of the network device from which the DHCP packet was received is determined. An identifier associated with the port is determined. An option in the DHCP packet is marked by the network device using the identifier. The marked DHCP packet is transmitted along a forwarding path.

### I. BACKGROUND

It is common in conventional computing environments to connect a plurality of computing systems and devices through a communication medium often referred to as a network. Network communication media and protocols may be packet oriented whereby information that is to be exchanged over the network is broken into discrete sized packets of information.

Network traffic, and/or network packets sent over a network may damage a computer system or otherwise negatively affect it. A denial of service (DoS) attack is designed to prevent legitimate access to a resource, such that packets from a malicious computer system or host can flood a victim host's connection to prevent legitimate packets from getting through. The packets from the malicious host may cause unauthorized and damaging changes to the victim host. Dynamic Host Configuration Protocol (DHCP) servers are a common target for DOS and other types of network attacks.

To protect against such attack, it is desirable to track and locate the malicious host sending the information, network traffic, and/or network packets. In some situations, the address of the source malicious host sending the information, network traffic, and/or network packets is forged or spoofed. Additionally, all other standard identification information in the packet that points to the source host can be spoofed. This makes it difficult to track the source malicious host.

### II. BRIEF DESCRIPTION OF THE DRAWINGS

The present disclosure may be better understood and its numerous features and advantages made apparent to those skilled in the art by referencing the accompanying drawings.

FIG. 1 is a block diagram of a network in accordance with an embodiment of the invention.

FIG. 2 is a simplified high-level block diagram of a packet including a DHCP traceback option in accordance with an embodiment of the invention.

FIG. 3 is a simplified flow diagram depicting a method of marking a packet with edge network device information in accordance with an embodiment of the invention.

FIG. 4 is a simplified flow diagram depicting a method of traceback within a set of trusted network devices in accordance with an embodiment of the invention.

FIG. 5 is a block diagram of an exemplary packet switch in accordance with an embodiment of the invention.

### III. DETAILED DESCRIPTION

Network devices and protocols associated therewith may be used for marking a Dynamic Host Configuration Protocol (DHCP) packet and quarantining a source of the marked DHCP packet in a trusted network, the trusted network including a plurality of trusted network devices and a trusted host. DHCP is specified under RFC 2131. A DCHP packet may be received at a network device of the trusted network. An IP header of the DHCP packet includes a source IP address and a destination IP address. Any portion of a transmission path of the DHCP packet which is outside of a trusted network may compromise the integrity of the source IP address. For example, a Denial of Service (DoS) attack may interject packets with incorrect or spoofed IP addresses into the trusted network, thus disguising the origin of the attacks.

Nefarious DHCP packets having a spoofed or otherwise not trusted source address can be traced back to the sender host, which is then quarantined from a trusted network.

A. DHCP Packet Marking

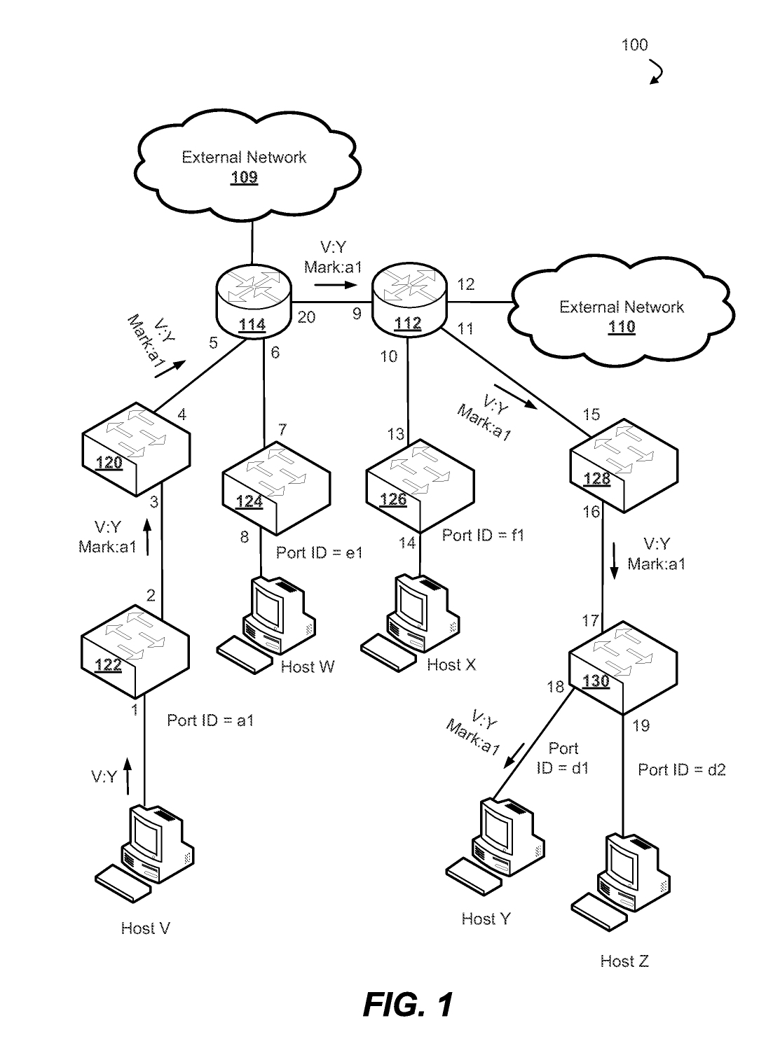

FIG. 1 is a block diagram of a network 100 in accordance with an embodiment of the invention. Network 100 includes router 112, router 114, switch 120, switch 122, switch 124, switch 126, switch 128, and switch 130, all of which are a part of a trusted network. As used herein, a trusted network is comprised of a plurality of trusted network devices and one or more trusted hosts over which a network monitoring module of a network management device or an administrative entity maintains control. In one embodiment, the trusted network is a local access network (LAN). Network 100 also includes external network 109 and external network 110, which is coupled to the trusted network via routers 114 and 112, respectively.

Host device V is operatively coupled to switch 122. Host device W is operatively coupled to switch 124. Host device X is operatively coupled to switch 126. Host devices Y and Z are operatively coupled to switch 130. One or more of Host devices V-Z are not a part of the trusted network, i.e., are not trusted devices. In one embodiment, one or more of Host devices V-Z are malicious hosts configured to send DHCP packets with spoofed source IP addresses into the trusted network.

Switches 120-130 and routers 112 and 114 are configured to forward, analyze, and/or filter packets. Edge network devices, such as switch 122, switch 124, switch 126, switch 130, and router 112 are further configured to mark DHCP packets with an identifier associated with an edge port of the edge network device at the point of entry of the DHCP packet into a trusted network. As used herein, an edge network device is a trusted switch, trusted router, or other trusted network device that is connected to a host via an edge port, connected to an external network via the edge port, or is otherwise configured to mark DHCP packets. As used herein, an edge port is a port in a trusted edge network device which is directly connected to a host or external network.

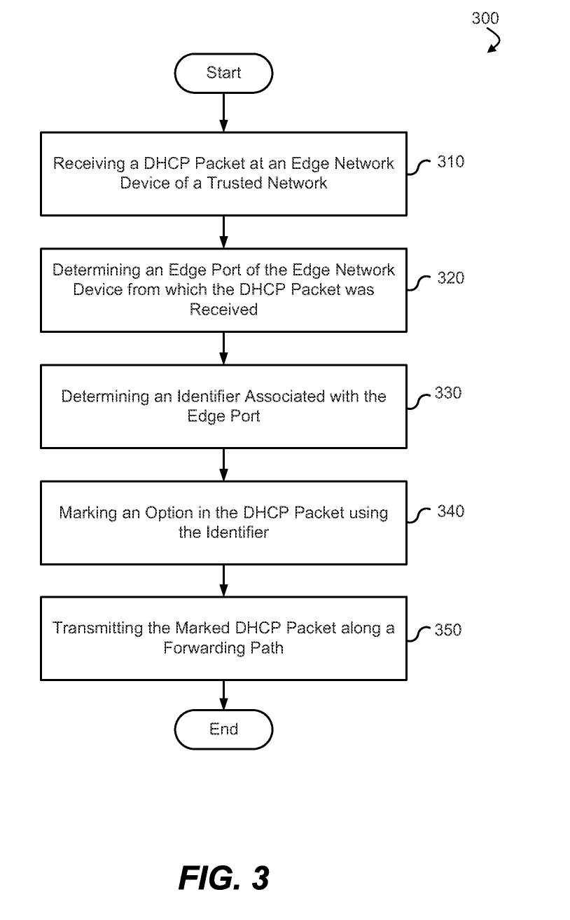

In accordance with an embodiment, the edge ports of the edge network devices in the trusted network are associated with an identifier which uniquely identifies one edge port from others in the trusted network. Port 1 of switch 122 is an edge port associated with identifier “a1.” Port 8 of switch 124 is an edge port associated with identifier “e1.” Port 14 of switch 126 is an edge port associated with identifier “f1.” Port 18 of switch 130 is an edge port associated with identifier “d1.” Port 19 of switch 130 is an edge port associated with identifier “d2.” One example of determining the identifier associated with the edge port is described further below in relation to FIG. 3.

In one embodiment, a DHCP packet is marked by an edge network device along a forwarding path of a DHCP packet. For example, a DHCP packet is sent from source Host V to destination Host Y. In one embodiment, Host V is a malicious host and Host Y is a trusted device. For example, Host Y is a DHCP server. The DHCP packet from Host V follows a forwarding path into edge port 1 of switch 122, out of port 2 of switch 122 to port 3 of switch 120, out of port 4 of switch 120 to port 5 of router 114, out of port 20 of router 114 to port 9 of router 112, out of port 11 of router 112 to port 15 of switch 128, out of port 16 of switch 128 to port 17 of switch 130, out of port 18 of switch 130 to the destination Host Y.

Switch 122 marks the DHCP packet with the identifier associated with edge port 1, which is the entry point of the DHCP packet into the trusted network. The marked DHCP packet may be propagated out of port 2 of switch 122 and continued along the forwarding path.

In one embodiment, the forwarding path may be to another external network, such as external network 109. The DHCP packet may be generated by a malicious host in external network 110. The path of the packet may traverse the trusted network, being destined to a device in external network 109. For example, a malicious client in the first local network may send a packet to an internet service provider (ISP) and the packet may be destined to a device in a second local network. From the vantage of the ISP, the local networks are not trusted. The packet is marked by a trusted edge device of the ISP. A network monitoring module of the ISP monitors the trusted network nodes and when a triggering event is detected, the malicious client is quarantined from the ISP network.

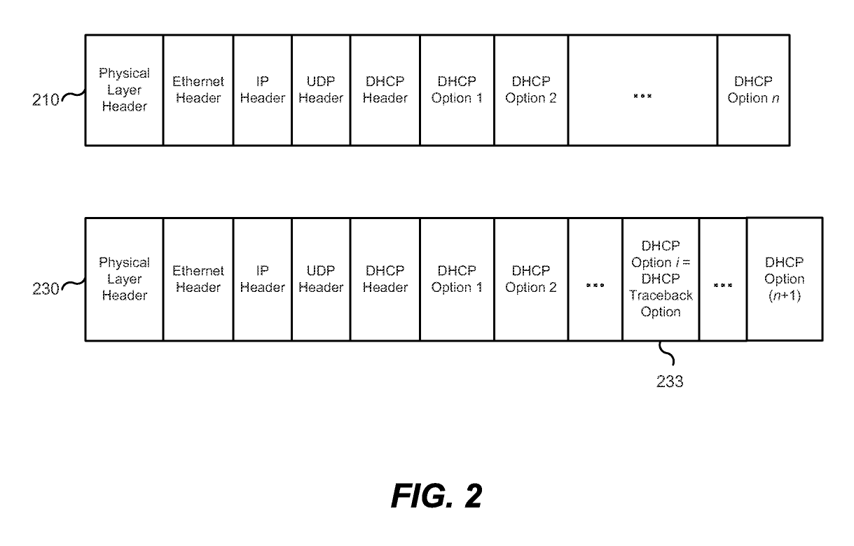

FIG. 2 is a simplified high-level block diagram of a packet including a DHCP traceback option in accordance with an embodiment of the invention. In one embodiment, packet 210 is a Dynamic Host Configuration Protocol (DHCP) packet before marking is performed. DHCP packet 210 is an application layer packet which may be used in a DHCP environment. In general, DHCP messages may be used by a host to discover a boot server, i.e., a server that delivers executables for booting a client. In one embodiment, a DHCP server provides standard DHCP services such as providing communications-related configuration values to a host during the host's boot process. Configuration values may include a dynamically-allocated IP address. As such, the host may obtain an IP address from a DHCP server. In another embodiment, the DHCP message format may be used for communications not related to standard DHCP services.

As shown, DHCP packet 210 includes a physical layer header, Ethernet header, IP header, UDP header, DHCP header, and one or more DHCP options, such as DHCP Option 1, DHCP Option 2 . . . DHCP Option n, where n is an integer. The DHCP options may have variable sizes.

In one embodiment, packet 230 is a DHCP packet after marking is performed. DHCP packet 230 includes similar fields as shown in DHCP packet 210, with the addition of a DHCP traceback option 233. DHCP traceback option 233 is inserted randomly in the list of options of DHCP packet 230. As shown, DHCP traceback option 233 is inserted at a position DHCP Option i, where i is a randomly picked number in the range 1−(n+1).

DHCP traceback option 233 comprises an identifier associated with an edge port of an edge network device. Upon detecting a triggering event, the identifier may be used to determine the source host of a suspicious packet.

Typically, DHCP options follow the following formatting convention:

<Op-code, length, value>. The value field is the data of the option. The operation code (Op-code) and the length fields comprise the metadata of the option. The op-code field may be a unique value used for identifying an option associated with it. The length field specifies the length of the value.

In one embodiment, DHCP traceback option 233 is associated with an op-code. The DHCP traceback option may be formatted as <Op-code, length of Port Identifier, Port Identifier>, such that the port identifier occupies the value field and a length of the port identifier occupies the length field.

In another embodiment, for example, where end nodes and non-end nodes mark the DHCP packet, the value field may be occupied by a multiple port identifiers and the length field may be occupied by multiple lengths, such that value={Port Identifier 1, Port Identifier 2, . . . }, and length=length of (Value). In one embodiment, when a non-edge device appends its port identifier to the value field, the non-edge device also updates the length field of DHCP traceback option 233.

FIG. 3 is a simplified flow diagram depicting a method of marking a packet with edge network device information in accordance with an embodiment of the invention. The depicted process flow 300 is carried out by execution of one or more sequences of executable instructions. In another embodiment, the process flow 300 is carried out by execution of components of a network node, an arrangement of hardware logic, e.g., an Application-Specific Integrated Circuit (ASIC), etc.

At step 310, a DHCP packet is received at an edge network device of a trusted network. In one embodiment, an edge network device may include a switch or router. An edge port of the edge network device from which the DHCP packet was received is determined at step 320.

At step 330, an identifier associated with the edge port is determined. The port identifier enables each edge port of the trusted network to be uniquely identified. In one embodiment, the identifier is a pre-calculated fingerprint of the edge port and is assigned to the edge port before marking is performed. The port identifier may be calculated by applying a cryptographic hash function using an address of the edge network device, such as a Media Access Control (MAC) address, and a physical port number of the edge port. The hash value is unique for each edge port in the trusted network. It should be noted that any robust hash function, such as secure hash algorithm 1 (SHA-1), may be applied. The port identifier is assigned to or otherwise associated with each of the edge ports by an administrative entity, such as a network administrator. The administrative entity may maintain a data store which maps the port identifier to the associated edge network device and/or edge port number.

In another embodiment, the port identifier is determined by using the MAC address of the edge network device network device and the physical port number of the edge port, for example by concatenating the address of the edge network device, such as a MAC address, and the physical port number of the edge port. As such, a record of the mapping between the port identifier to the associated edge network device and/or edge port number may not be maintained. There is low processing overhead in executing the concatenation operation.

At step 340, an option in the DHCP packet is marked using the identifier. For example, the edge network device or other trusted network device inserts a DHCP traceback option in the received DHCP packet. The DHCP traceback option includes the port identifier.

A list of one or more options may be already present in the DHCP packet. Typically, options are written in an IP option or at the end of an option list. The DHCP traceback option, however, is inserted randomly in the list of options. Insertion of the option at a random location within the list of options makes it challenging for a malicious host to bypass the traceback process even if the DHCP packet is fragmented.

For example, the DHCP packet may be fragmented by an intermediate node along the forwarding path. The DHCP traceback option may be present in a single fragment. The packet may be sent outside of the trusted network along the forwarding path. Since the DHCP traceback option is placed randomly in the option list, the malicious host cannot easily predict which fragment will contain the DHCP option when the packet is fragmented in the forwarding path. As such, the malicious host may not be able to craft the packet such that a targeted fragment will predictably cause the intended disruption to the network and not contain the DHCP traceback option. The malicious host has a 1/n (n is the number of fragments) chance in predicting which fragment will include the DHCP traceback option.

If there is an existing value in the options field, it may be replaced. The identifier may be used during traceback for determining the source of a spoofed DHCP packet. The marked DHCP packet is transmitted along a forwarding path at step 350.

In another embodiment, the marking functionality may be also performed by non-edge network devices of the trusted network. As the DHCP packet travels through the forwarding path, the edge network device inserts the DHCP traceback option and each non-edge network device appends to the DHCP traceback option an identifier associated with a non-edge port from which the DHCP packet was received of the non-edge network device. In another embodiment, the non-edge network device replaces any existing values in the DHCP traceback option.

B. DHCP Packet Traceback

In one embodiment, a plurality of trusted network devices and the trusted hosts are monitored, for example by a network monitoring module or an administrative entity. The trusted network may be monitored for various events. When a triggering event is detected, a traceback process is initiated. A triggering event may include an unexpected state or other unexpected behavior in the trusted network. For example, an attacking packet may be received by a destination host. The attacking packet may cause disruption in the state of the destination host. The destination host may be monitored and the detection of the disrupted state (e.g., host crashes, shows anomalous behavior, etc.) of the destination host may trigger the traceback process. Once the triggering event is detected, the attacking packet or fragment thereof is provided, for example, to the network monitoring module or administrative entity.

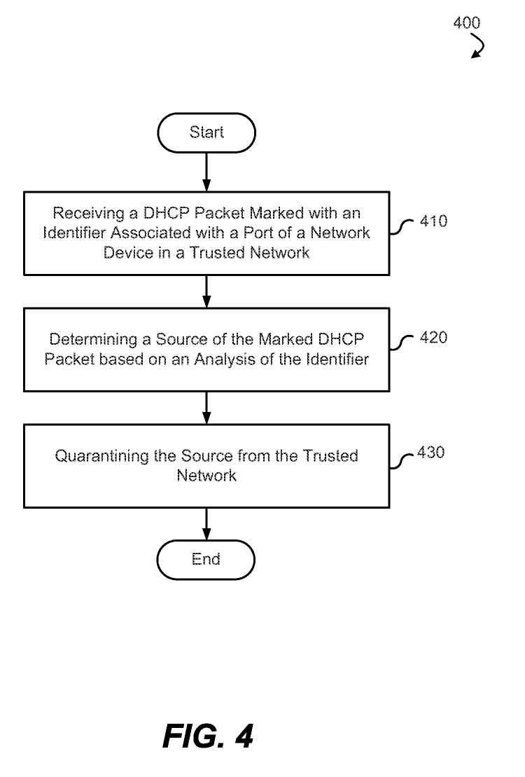

FIG. 4 is a simplified flow diagram depicting a method of traceback within a set of trusted network devices in accordance with an embodiment of the invention. The depicted process flow 400 is carried out by execution of one or more sequences of executable instructions. In another embodiment, the process flow 400 is carried out by execution of components of a network node, an arrangement of hardware logic, e.g., an Application-Specific Integrated Circuit (ASIC), etc.

At step 410, a DHCP packet marked with an identifier associated with a port of a network device in a trusted network is received. The identifier may be associated with an edge port of an edge network device in the trusted network. In one embodiment, a network monitoring module or administrative entity having control over the trusted network detects a triggering event. In one embodiment, upon detection of the triggering event, the DHCP packet, a copy of the DHCP packet, or a portion thereof including the identifier (i.e., a fragment) may be retrieved by or otherwise received by the network monitoring module or administrative entity.

At step 420, a source of the marked DHCP packet is determined based on an analysis of the identifier. For example, the port identifier is extracted from a fragment of DHCP packet and mapped to the associated edge network device and/or edge port number. In another example, the port identifier is extracted from the DHCP packet and the MAC address of the edge network device and the physical port number of the edge port are determined from the port identifier. Since the physical ports of network devices are mapped to an address of the hosts connected thereto, a true address of the host from which the DHCP packet originated can be identified as being a source when the edge port is known.

In some situations, identification of the host from which the DHCP packet originated is not feasible. In one embodiment, the edge network device may be connected to an external network (i.e., not trusted network) via the edge port of the edge network device. A malicious host may be connected to the external network. When the DHCP packet enters the trusted network at the edge port, the integrity of the source IP address in the DHCP packet may have been compromised. Since the edge port is not directly connected to the malicious host, it is not possible to discern the true address of the malicious host.

Regardless, attacks from the malicious host may be throttled at trusted network devices which are a distance from the malicious host. For example, the DHCP may have traversed multiple routers in the forwarding path before reaching the edge port of the edge network device. Instead of identifying the malicious host as the source, the edge port may be identified as such. Typically, packets follow a same or similar forwarding path. For example, packets from a distant malicious host will typically enter the trusted network through the same edge port. As such, the edge port can be identified as the source for purposes of instituting a quarantine procedure against the distant malicious host.

At step 430, the source is quarantined from the trusted network. In one embodiment, the edge port and/or the edge network device connected to the source may be disabled upon determining the source of the DHCP packet. In another embodiment, where the edge port itself is identified as the source, the edge port may be disabled. Other known methods of establishing a quarantine procedure may also be applied.

As previously discussed, an entry point of a DHCP packet into a trusted network may be determined. The marking approaches incur a low overhead for the network devices. Some traceback algorithms perform a path reconstruction process to identify the source of an attack. As described herein, the source is identified without the high computation overhead of reconstructing an attack path. As such, a source of a DHCP packet may be identified in a computationally efficient manner.

Moreover, using DHCP options, as opposed to IP options, the identifier of the edge port is carried by the single packet. In one embodiment, the identifier is pre-computed, for example during setup, making the marking process performed by the network device highly efficient.

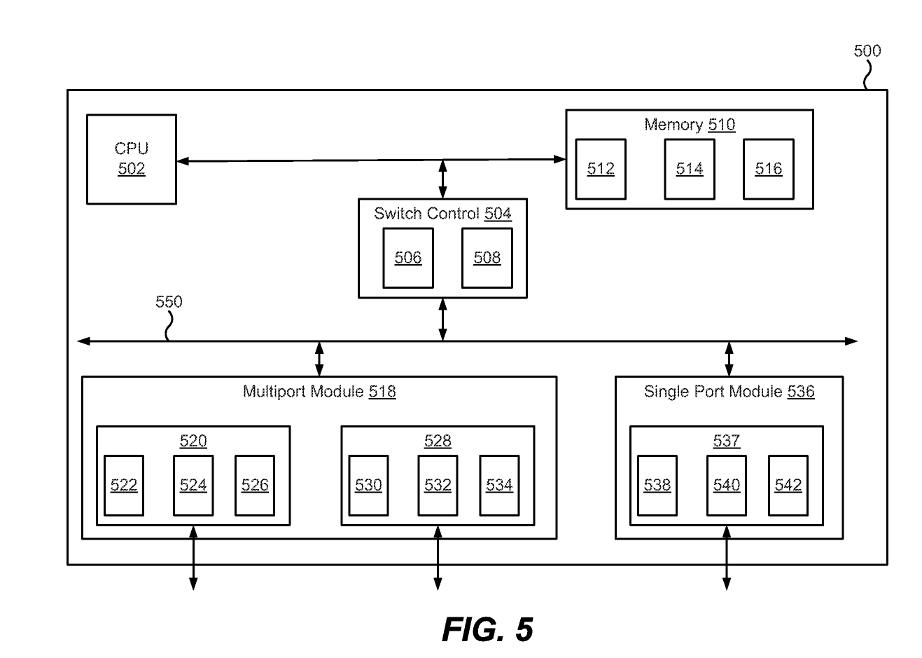

FIG. 5 is a block diagram of an exemplary packet switch in accordance with an embodiment of the invention. The specific configuration of packet switches used may vary depending on the specific implementation. A central processing unit (CPU) 502 performs overall configuration and control of the switch 500 in operation. The CPU 502 operates in cooperation with switch control 504, an application specific integrated circuit (ASIC) designed to assist CPU 502 in performing packet switching at high speeds.

The switch control 504 controls the “forwarding” of received packets to appropriate locations within the switch for further processing and/or for transmission out another switch port. Inbound and outbound high speed FIFOs (506 and 508, respectfully) are included with the switch control 504 for exchanging data over switch bus 550 with port modules. In accordance with an embodiment of the invention, the switch control 504 is an ASIC and is configured to insert and analyze a port identifier within a location in a packet.

Memory 510 includes a high and low priority inbound queue (512 and 514, respectively) and outbound queue 516. High priority inbound queue 512 is used to hold received switch control packets awaiting processing by CPU 502 while low priority inbound queue 514 holds other packets awaiting processing by CPU 502. Outbound queue 516 holds packets awaiting transmission to switch bus 550 via switch control 504 through its outbound FIFO 508. CPU 502, switch control 504 and memory 510 exchange information over processor bus 550 largely independent of activity on switch bus 550.

The ports of the switch may be embodied as plug-in modules that connect to switch bus 550. Each such module may be, for example, a multi-port module 518 having a plurality of ports in a single module or may be a single port module 536. A multi-port module provides an aggregate packet switch performance capable of handling a number of slower individual ports. For example, in one embodiment, both the single port module 536 and the multi-port module 518 may be configured to provide, for example, approximately 1 Gbit per second packet switching performance. The single port module 536 therefore can process packet switching on a single port at speeds up to 1 Gbit per second. The multi-port module 518 provides similar aggregate performance but distributes the bandwidth over, preferably, eight ports each operating at speeds, for example, of up to 100 Mbit per second. These aggregated or trunked ports may be seen as a single logical port to the switch.

Each port includes high speed FIFOs for exchanging data over its respective port. Specifically, each port, 520, 528, and 537, preferably includes an inbound FIFO 522, 530, and 538, respectively for receiving packets from the network medium connected to the port. Further, each port 520, 528, and 537, preferably includes a high priority outbound FIFO 524, 532, and 540, respectively, and a low priority outbound FIFO 526, 534, and 542, respectively. The low priority outbound FIFOs are used to queue data associated with transmission of normal packets while the high priority outbound FIFO is used to queue data associated with transmission of control packets. Each module (518 and 536) includes circuits (not specifically shown) to connect its port FIFOs to the switch bus 550.

As packets are received from a port, the packet data is applied to the switch bus 550 in such a manner as to permit monitoring of the packet data by switch control 504. In general, switch control 504 manages access to switch bus 550 by all port modules (i.e., 518 and 536). All port modules “listen” to packets as they are received and applied by a receiving port module to switch bus 550. If the packet is to be forwarded to another port, switch control 504 applies a trailer message to switch bus 550 following the end of the packet to identify which port should accept the received packet for forwarding to its associated network link.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage medium that are suitable for storing a program or programs that, when executed, for example by a processor, implement embodiments of the present invention. Accordingly, embodiments provide a program comprising code for implementing a system or method as claimed in any preceding claim and a machine readable storage medium storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A method for processing a Dynamic Host Configuration Protocol (DHCP) packet in a trusted network, the trusted network including a plurality of trusted network devices and a trusted host, the method comprising:
receiving the DHCP packet at a network device of the trusted network;
determining a port of the edge network device from which the DHCP packet was received;
determining an identifier associated with the port;
marking by the network device an option in the DHCP packet using the identifier; and
transmitting the marked DHCP packet along a forwarding path.

2. The method of claim 1, wherein the identifier uniquely identifies the port among a plurality of ports of the trusted network.

3. The method of claim 1, wherein the identifier is a hash value determined by applying a hash function using an address of the network device and a physical port number of the port.

4. The method of claim 1, wherein the identifier is a concatenation of an address of the network device and a physical port number of the port.

5. The method of claim 1, wherein marking further comprises inserting the option at a random location in the DHCP packet.

6. The method of claim 1, wherein the network device is an edge network device of the trusted network.

7. The method of claim 1, wherein a source of the DHCP packet is determined based on an analysis of the identifier.

8. A network device for use in a trusted network for processing a Dynamic Host Configuration Protocol (DHCP) packet, the device comprising:
a plurality of ports;
a switch controller coupled to the plurality of ports, wherein the switch controller is configured to:
determine a port of the plurality of ports from which the DHCP packet was received;
determine an identifier associated with the port; and
mark an option in the DHCP packet using the identifier.

9. The network device of claim 8, wherein the identifier uniquely identifies the port among a plurality of ports of the trusted network.

10. The network device of claim 8, wherein the identifier is a hash value determined by applying a hash function using an address of the network device and a physical port number of the port.

11. The network device of claim 8, wherein the identifier is a concatenation of an address of the network device and a physical port number of the port.

12. The network device of claim 8, wherein the switch controller is further configured to insert the option at a random location within a list of options in the DHCP packet.

13. The network device of claim 8, wherein the network device is an edge network device of the trusted network.

14. A computer-readable medium storing a plurality of instructions for controlling a data processor to quarantine a source of a Dynamic Host Configuration Protocol (DHCP) packet in a trusted network, the trusted network including a plurality of trusted network devices and a trusted host, the plurality of instructions comprising:
instructions that cause the data processor to receive a DHCP packet marked with an identifier associated with a port of a trusted network device of the plurality of trusted network devices;
instructions that cause the data processor to determine a source of the DHCP packet based on an analysis of the identifier;
instructions that cause the data processor to quarantine the source from the trusted network.

15. The computer-readable medium of claim 14, wherein at least one of the trusted network device and the port is disabled upon determining the source of the DHCP packet.

16. The computer-readable medium of claim 14, wherein the plurality of instructions further comprise instructions that cause the data processor to:
monitor the plurality of trusted network devices and the trusted host; and
detect a triggering event in response to monitoring.

17. The computer-readable medium of claim 14, wherein the plurality of instructions further comprise instructions that cause the data processor to:
upon detection of the triggering event, receive a fragment of the marked DHCP packet, the fragment including the identifier.

18. The computer-readable medium of claim 17, wherein the plurality of instructions further comprise instructions that cause the data processor to:
extract the identifier from the fragment; and
determine at least one of the trusted network device and the port from the identifier.

19. The computer-readable medium of claim 14, wherein the plurality of instructions further comprise instructions that cause the data processor to quarantine the source from the trusted network.

20. The computer-readable medium of claim 14, wherein at least one of the trusted network device and the port is disabled upon determining the source of the DHCP packet.
